(19) United States
(12) Patent Application Publication
(10) Pub. No.: US 2026/0238945 A1
(43) Pub. Date: Aug. 13, 2026

(54) USER DEVICE, A METHOD FOR OPERATING THE USER DEVICE AND AUDIO SYSTEM

(71) Applicant: Samsung Electronics Co., Ltd., Suwon-si (KR)

(72) Inventors: Wondeuk YOON, Suwon-si (KR); Sangho LEE, Suwon-si (KR); Woonki LEE, Suwon-si (KR)

(73) Assignee: Samsung Electronics Co., Ltd., Suwon-si (KR)

(21) Appl. No.: 19/391,479

(22) Filed: Nov. 17, 2025

(30) Foreign Application Priority Data
Feb. 12, 2025 (KR) 10-2025-0018054

(51) Int. Cl. H04S 7/00; G06F 3/16; H04S 3/00

(52) U.S. Cl. CPC H04S 7/301; G06F 3/162; H04S 3/008; H04S 2400/01; H04S 2400/13

(57) ABSTRACT

A user device according to embodiments may include a memory, and processing circuitry configured to cause the user device to generate a first request for a wireless communication connection with an external device, generate a second request for receiving profile information of the external device, calculate a distance to the external device, generate a control signal for controlling an output of the external device based on the profile information and the distance, load sound data from the memory, and convert the sound data into a format for transmission to the external device.

### CROSS-REFERENCE TO RELATED APPLICATION

This application claims priority to and the benefit of Korean Patent Application No. 10-2025-0018054 filed with the Korean Intellectual Property Office on Feb. 12, 2025, the entire contents of which are incorporated herein by reference.

### BACKGROUND

### (a) Field

The present disclosure relates to a user device for performing sound surround automatic correction, a method of operating the user device, and an audio system.

### (b) Description of the Related Art

Wireless sound systems have evolved to provide users with a convenient and free audio experience. In particular, with the advancement of Bluetooth Low Energy (BT LE) audio technology, devices have been developed that build multiple wireless sound channels, or sound surround systems, while maintaining stable connections and higher data transmission efficiency even in lower-power states.

However, even now, when building a sound surround system using multiple speakers, users still suffer the inconvenience of manually adjusting the sound volume and sound delay synchronization of each speaker.

### SUMMARY

Embodiments relates to a user device capable of controlling the output of an audio sink device in real time, a method of operating the user device, and an audio system.

According to embodiments of the inventive concepts for addressing these technical challenges, a user device may include a memory, and processing circuitry configured to cause the user device to generate a first request for a wireless communication connection with an external device, generate a second request for receiving profile information of the external device, calculate a distance to the external device, generate a control signal for controlling an output of the external device based on the profile information and the distance, load sound data from the memory, and convert the sound data into a format for transmission to the external device.

A method for operating a user device according to embodiments may include generating a first request for a wireless communication connection with an external device, generating a second request for receiving profile information of the external device, calculating a distance to the external device, generating a control signal for controlling an output of the external device based on the profile information and the distance, and controlling the output of the external device.

An audio system according to embodiments may include a plurality of audio sink devices, and an audio source device configured to calculate distances to each of the plurality of audio sink devices at a first point in time to obtain first distances, recalculate the first distances to each of the plurality of audio sink devices at a second point in time to obtain second distances, the second point in time being subsequent to the first point in time, determine whether a condition is satisfied, and adjust a sound pressure level and a delay of each among the plurality of audio sink devices based on profile information of each of the plurality of audio sink devices and the second distances in response to determining the condition is satisfied.

A method for operating a user device according to embodiments may include calculating distances to each of the plurality of audio sink devices at a first point in time to obtain first distances, recalculating the first distances to each of the plurality of audio sink devices at a second point in time to obtain second distances, the second point in time being subsequent to the first point in time, determining whether a condition is satisfied, and adjusting a sound pressure level and a delay of each among the plurality of audio sink devices based on profile information of each of the plurality of audio sink devices and the second distances in response to determining the condition is satisfied.

A non-transitory computer-readable medium storing instructions that, when executed by processing circuitry, cause the processing circuitry to perform a method, the method including generating a first request for a wireless communication connection with an external device, generating a second request for receiving profile information of the external device, calculating a distance to the external device, generating a control signal for controlling an output of the external device based on the profile information and the distance, and controlling the output of the external device.

A non-transitory computer-readable medium storing instructions that, when executed by processing circuitry, cause the processing circuitry to perform a method, the method including calculating distances to each of the plurality of audio sink devices at a first point in time to obtain first distances, recalculating the first distances to each of the plurality of audio sink devices at a second point in time to obtain second distances, the second point in time being subsequent to the first point in time, determining whether a condition is satisfied, and adjusting a sound pressure level and a delay of each among the plurality of audio sink devices based on profile information of each of the plurality of audio sink devices and the second distances in response to determining the condition is satisfied.

### BRIEF DESCRIPTION OF THE DRAWINGS

FIG. 1 is a drawing for explaining an audio system according to embodiments of the present disclosure.

FIG. 2 is a drawing for explaining an audio system according to embodiments of the present disclosure.

FIG. 3 is a block diagram for explaining an audio system according to embodiments of the present disclosure.

FIG. 4 is a block diagram for explaining an audio source device according to embodiments of the present disclosure.

FIG. 5 is a block diagram for explaining an audio sink device according to embodiments of the present disclosure.

FIG. 6 is a block diagram for explaining an audio system according to embodiments of the present disclosure.

FIG. 7 is a flowchart for explaining a sound surround automatic correction method according to embodiments of the present disclosure.

FIG. 8 is a diagram for explaining a sound surround automatic correction method according to embodiments of the present disclosure.

FIG. 9 is a diagram for explaining a sound surround automatic correction method according to embodiments of the present disclosure.

FIG. 10 is a drawing for explaining a sound surround automatic correction method according to embodiments of the present disclosure.

FIG. 11 is a drawing for explaining a sound surround automatic correction method according to embodiments of the present disclosure.

FIG. 12 is a drawing for explaining a sound surround automatic correction method according to embodiments of the present disclosure.

FIG. 13 is a flowchart for explaining a sound surround automatic correction method according to embodiments of the present disclosure.

FIG. 14 is a block diagram exemplarily illustrating a mobile system according to embodiments of the present disclosure.

### DETAILED DESCRIPTION

In the following detailed description, only certain examples of the present inventive concepts have been shown and described, simply by way of illustration. As those skilled in the art would realize, the described examples may be modified in various different ways, all without departing from the spirit or scope of the present inventive concepts.

Accordingly, the drawings and description are to be regarded as illustrative in nature and not restrictive. Like reference numerals designate like elements throughout the specification. In the flow charts described with reference to the drawings, the order of operations may be changed, and several operations may be combined, and an operation may be divided, and some operations may not be performed.

Further, expressions written in the singular forms may be comprehended as the singular forms or plural forms unless clear expressions such as “a”, “an”, or “single” are used. Terms including an ordinal number, such as first and second, are used for describing various constituent elements, but the constituent elements are not limited by the terms. These terms are used only to discriminate one constituent element from other constituent elements.

Hereinafter, the present disclosure will be described in more detail through examples. These examples are just for illustrating the present disclosure, and the right protection scope of the present disclosure is not limited by the examples.

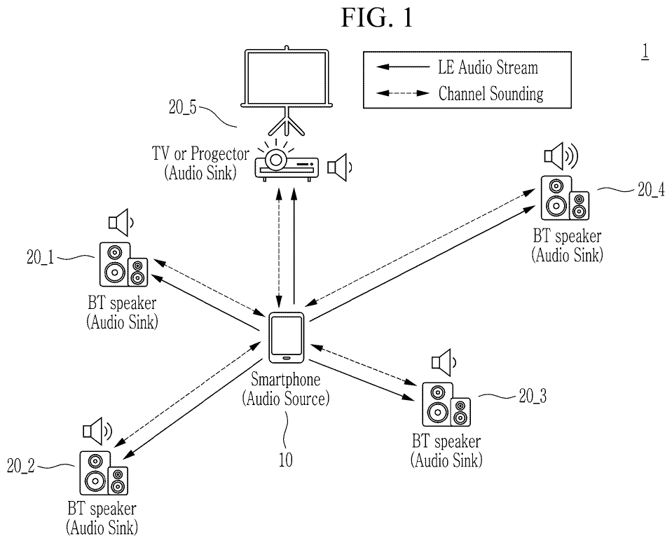

FIG. 1 is a drawing for explaining an audio system according to embodiments of the present disclosure.

Referring to FIG. 1, an audio system 1 may include an audio source device 10 and a plurality of audio sink devices 20_1 to 20_5 (e.g., a first audio sink device 20_1, a second audio sink device 20_2, a third audio sink device 20_3, a fourth audio sink device 20_4 and a fifth audio sink device 20_5).

An audio source device 10 may refer to a device that provides audio data (or sound data) to a plurality of audio sink devices 20_1 to 20_5. As illustrated in FIG. 1, the audio source device 10 may include a user device such as a smart phone. According to embodiments, the audio source device 10 may be fixed or mobile and may refer to any device that may communicate with one or more among the plurality of audio sink devices 20_1 to 20_5 to transmit and receive sound data and/or control information. For example, the audio source device 10 may be referred to as a terminal, a terminal equipment, a mobile station (MS), a mobile terminal (MT), a user terminal (UT), a subscriber station (SS), a wireless device, a handheld device, or the like.

Each of the plurality of audio sink devices 20_1 to 20_5 may receive audio data from the audio source device 10 and output a corresponding sound based on the received audio data. The plurality of audio sink devices 20_1 to 20_5 may be implemented as speakers, TVs, or projectors, but embodiments are not necessarily limited thereto.

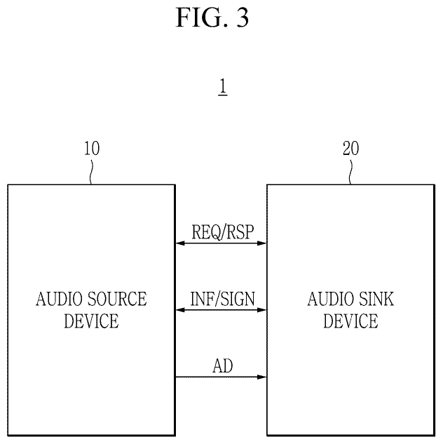

The audio source device 10 and a plurality of audio sink devices 20_1 to 20_5 may be connected based on BT LE (BlueTooth Low Energy). The audio source device 10 may transmit audio data to the plurality of audio sink devices 20_1 to 20_5 connected via BT LE. Additionally, the audio source device 10 may calculate the distance between each of the plurality of audio sink devices 20_1 to 20_5 based on channel sounding. Specific details are explained with reference to FIG. 3 and below.

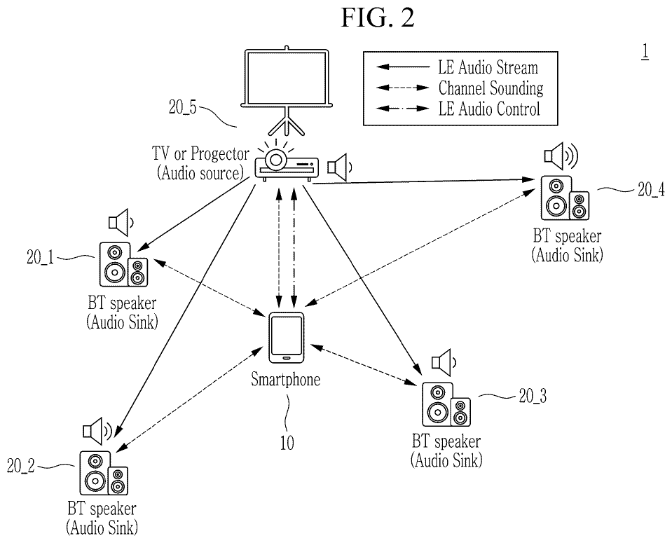

FIG. 2 is a drawing for explaining an audio system according to embodiments of the present disclosure. Below, the differences from the example illustrated in FIG. 1 are mainly explained.

Referring to FIG. 2, among the plurality of audio sink devices 20_1 to 20_5, one specific audio sink device 20_1 to 20_5 may provide audio data to another audio sink device 20_1 to 20_4. The specific audio sink device 20_5 and other audio sink devices 20_1 to 20_4 may be wirelessly connected based on BT LE.

A user device 10 (may also be referred to herein as an audio source device 10) such as a smartphone may also be wirelessly connected to the plurality of audio sink devices 20_1 to 20_5 based on BT LE. At this time, the user device 10 does not provide audio data to the plurality of audio sink devices 20_1 to 20_5, but may calculate the distance to each of the plurality of audio sink devices 20_1 to 20_5 based on channel sounding. The user device 10 may control sounds output from the plurality of audio sink devices 20_1 to 20_5 based on the calculated distance and profile information of the plurality of audio sink devices 20_1 to 20_5.

Below, embodiments will be described from the perspective that a user device 10 operates as an audio source device to provide audio data and has a function of controlling the output of a plurality of audio sink devices 20_1 to 20_5.

FIG. 3 is a block diagram for explaining an audio system according to embodiments of the present disclosure.

Referring to FIG. 3, the audio system 1 may include an audio source device 10 and an audio sink device 20. The audio source device 10 may have substantially the same configuration as (or a similar configuration to) the audio source device 10 illustrated in FIGS. 1 and 2, and the audio sink device 20 may have substantially the same configuration as (or a similar configuration to) any one of a plurality of audio sink devices 20_1 to 20_5.

The audio source device 10 may transmit a specific request REQ to the audio sink device 20, and in response, the audio sink device 20 may transmit a response RSP to the request REQ to the audio source device 10. The audio source device 10 and the audio sink device 20 may transmit and receive information INF and/or signals SIGN.

For example, the audio source device 10 may transmit a request REQ to the audio sink device 20 to receive profile information for the audio sink device 20, and the audio sink device 20 may transmit information INF corresponding to the profile information to the audio source device 10 along with a response RSP corresponding to the request REQ.

The audio source device 10 may also transmit audio data AD to the audio sink device 20. The audio sink device 20 may output a corresponding sound based on the received audio data AD.

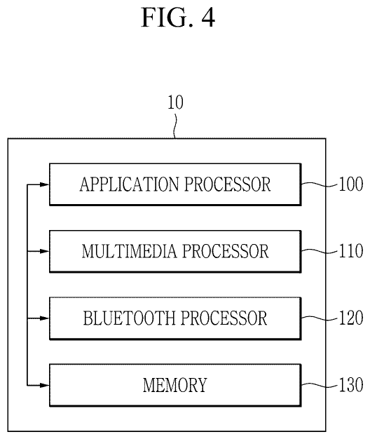

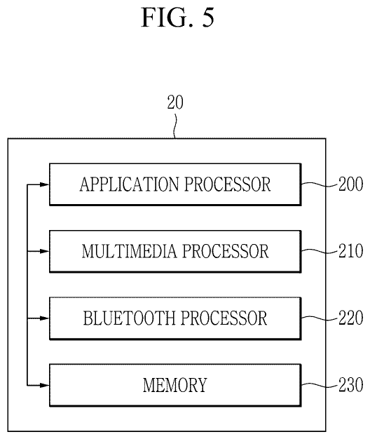

FIG. 4 is a block diagram for explaining an audio source device according to embodiments of the present disclosure. FIG. 5 is a block diagram for explaining an audio sink device according to embodiments of the present disclosure.

Referring to FIG. 4, the audio source device 10 may include an application processor 100, a multimedia processor 110, a Bluetooth processor 120, and/or a memory 130. Referring to FIG. 5, the audio sink device 20 may include an application processor 200, a multimedia processor 210, a Bluetooth processor 220, and/or a memory 230. That is, the audio source device 10 and the audio sink device 20 may each include substantially the same configuration (or similar configurations). For convenience of explanation, the operation of each component will be described below from the perspective of the audio source device 10.

The application processor 100 of the audio source device 10 may generate a request for a BT LE wireless connection with an external device, such as the audio sink device 20. The audio source device 10 may generate a request to receive profile information from an audio sink device 20. The audio source device 10 may calculate a distance from the audio source device 10 to the audio sink device 20 based on a channel sounding. The audio source device 10 may generate a control signal to control sound output from the audio sink device 20. The audio source device 10 may load audio data for transmission to the audio sink device 20 from a memory 130.

The multimedia processor 110 may receive audio data from the application processor 100 and convert the audio data into a format for transmission to the audio sink device 20. The Bluetooth processor 120 may manage a BT LE wireless connection with the audio sink device 20 and perform wireless communication with the audio sink device 20.

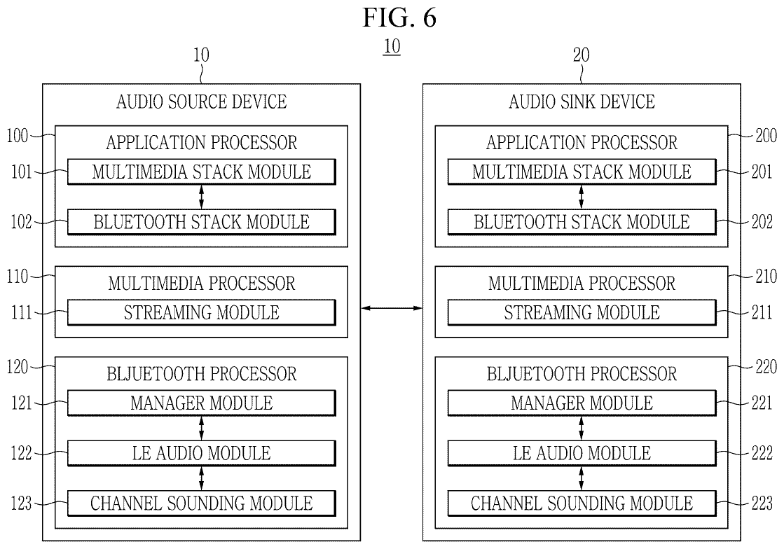

The memory 130 may store modules and/or software executed in each of the application processor 100, multimedia processor 110, and/or Bluetooth processor 120. Each of the application processor 100, multimedia processor 110, and/or Bluetooth processor 120 may load software from memory 130 to perform a specific function. A description of the modules that each of the application processor 100, multimedia processor 110, and/or Bluetooth processor 120 loads from memory 130 and executes will be described later with reference to FIG. 6.

FIG. 6 is a block diagram for explaining an audio system according to embodiments of the present disclosure.

Referring to FIG. 6, the audio source device 10 may include the application processor 100, the multimedia processor 110, and/or the Bluetooth processor 120. The application processor 100 may execute a multimedia stack module 101 and/or a Bluetooth stack module 102. The multimedia processor 110 may execute a streaming module 111. The Bluetooth processor 120 may execute a manager module 121, an LE audio module 122, and/or a channel sounding module 123.

The multimedia stack module 101 may load sounds from memory. The multimedia stack module 101 may request an audio data stream from the multimedia processor 110.

The Bluetooth stack module 102 may request a command from the Bluetooth processor 120 or receive and respond to a command. The Bluetooth stack module 102 may request or control the Bluetooth processor 120 to create, manage, and/or destroy Bluetooth wireless connections. The Bluetooth stack module 102 may calculate the distance to the audio sink device 20, and/or calculate the sound pressure level and/or delay of the audio sink device 20 based on the calculated distance and the received profile information.

The streaming module 111 may perform control over the stream of sound data. When a streaming module 111 receives a streaming request from a multimedia stack module 101, the streaming module 111 may convert sound data into a specific format so that the sound data may be wirelessly transmitted. The streaming module 111 may transmit the converted sound data to the Bluetooth stack module 102.

The manager module 121 may create, manage, and/or destroy a connection channel between the audio source device 10 and the audio sink device 20.

The LE audio module 122 may transmit and receive commands and responses from the Bluetooth stack module 102, and start and stop audio streaming based on these commands and/or responses.

The channel sounding module 123 may transmit and receive commands and responses from the Bluetooth stack module 102, and based on the commands and/or responses, transmit a channel sounding signal for calculating the distance to the audio sink device 20.

The audio sink device 20 may include the application processor 200, the multimedia processor 210, and/or the Bluetooth processor 220. The application processor 200 may execute a multimedia stack module 201 and/or a Bluetooth stack module 202. The multimedia processor 210 may execute a streaming module 211. The Bluetooth processor 220 may execute a manager module 221, an LE audio module 222, and/or a channel sounding module 223. The operation of each module of the audio sink device 20 is the same as or is similar to the operation of each corresponding module of the audio source device 10, and thus, specific details are omitted below.

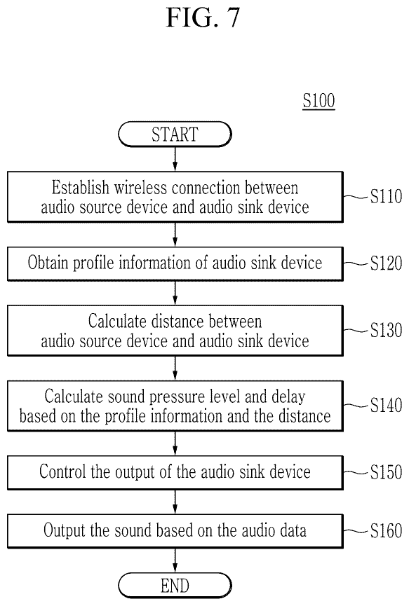

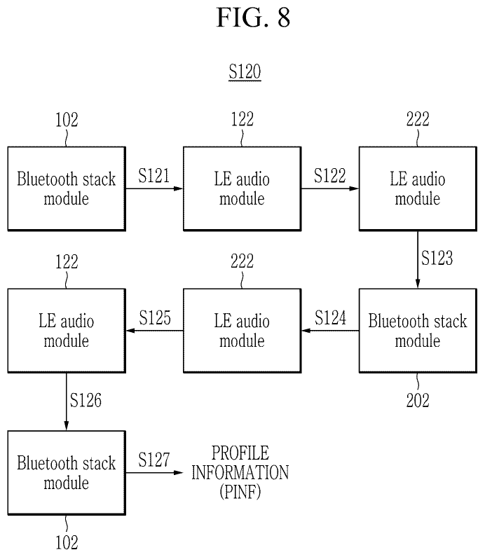

FIG. 7 is a flowchart for explaining a sound surround automatic correction method according to embodiments of the present disclosure. FIGS. 8 to 12 are drawings for explaining a sound surround automatic correction method according to embodiments of the present disclosure. As discussed herein, the term sound surround may also refer to surround sound.

Referring to FIG. 7, the sound surround automatic correction method S100 may include an operation S110 of establishing a wireless connection between an audio source device and an audio sink device. Specifically, the audio source device 10 may transmit a connection creation request for a wireless connection to the audio sink device 20, and conversely, the audio sink device 20 may also transmit a connection creation request for a wireless connection to the audio source device 10. In the operation S110 of establishing a wireless connection, initial values for the operation of LE Audio and/or channel sounding may be set.

The sound surround automatic correction method S100 may include an operation S120 of obtaining profile information of the audio sink device.

Specifically, referring to FIG. 8, the operation S120 of obtaining profile information of the audio sink device S120 includes an operation S121 in which the Bluetooth stack module 102 of the audio source device 10 transmits a request for receiving profile information of the audio sink device 20 to the LE audio module 122 of the audio source device 10, an operation S122 in which the LE audio module 122 of the audio source device 10 transmits the request to the LE audio module 222 of the audio sink device 20, an operation S123 in which the LE audio module 222 of the audio sink device 20 transmits the request to the Bluetooth stack module 202 of the audio sink device 20, an operation S124 in which the Bluetooth stack module 202 of the audio sink device 20 transmits the profile information of the corresponding audio sink device 20 to the LE audio module 222 of the audio sink device 20 in response to the request, an operation S125 in which the profile information of the corresponding audio sink device 20 is transmitted to the LE audio module 222 of the audio sink device 20 S125, an operation S126 in which in which the LE audio module 122 of the audio source device 10 transmits the corresponding profile information to the Bluetooth stack module 102 of the audio source device 10, and/or an operation S127 in which the Bluetooth stack module 102 of the audio source device 10 obtains the profile information PINF of the corresponding audio sink device 20.

In embodiments, if the audio sink device 20 does not transmit profile information in response to a profile information request, the audio source device 10 may load pre-stored (or alternatively, given or stored) profile information for the audio sink device 20.

Alternatively, in embodiments, if the audio sink device 20 does not transmit profile information in response to a profile information request, the user may directly input profile information for that audio sink device 20 into the audio source device 10.

The sound surround automatic correction method S100 may include an operation S130 of calculating a distance between an audio source device and an audio sink device.

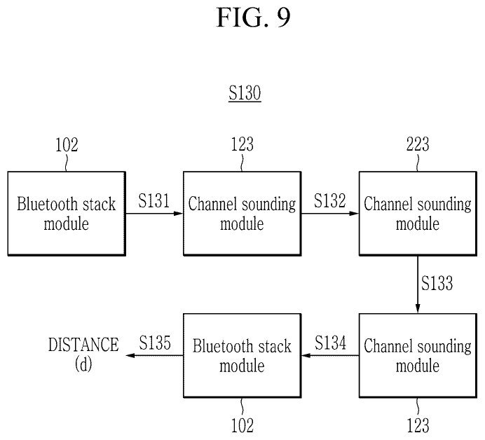

Specifically, referring to FIG. 9, the operation S130 of calculating the distance between the audio source device and the audio sink device includes an operation S131 of transmitting a request for calculating the distance from the Bluetooth stack module 102 of the audio source device 10 to the channel sounding module 123 of the audio source device 10 to calculate the distance from the audio sink device 20, an operation S132 of transmitting the request from the channel sounding module 123 of the audio source device 10 to the channel sounding module 223 of the audio sink device 20, an operation S133 of transmitting a signal (e.g., a test signal, a pilot signal, a reference signal, etc.) for calculating the distance to the channel sounding module 123 of the audio source device 10 in response to the request and signal received by the channel sounding module 223 of the audio sink device 20, an operation S134 of transmitting the signal received by the channel sounding module 123 of the audio source device 10 to the Bluetooth stack module 102 of the audio source device 10, and/or an operation S135 of calculating a distance d between the audio source device 10 and the audio sink device 20 through a distance calculation algorithm based on a signal provided by the Bluetooth stack module 102 of the audio source device 10.

In embodiments, the operation S120 of obtaining profile information and the operation S130 of calculating distance may be performed simultaneously (or contemporaneously). Alternatively, in embodiments, the operation S120 of obtaining profile information may be performed subsequent to the operation S130 of calculating distance.

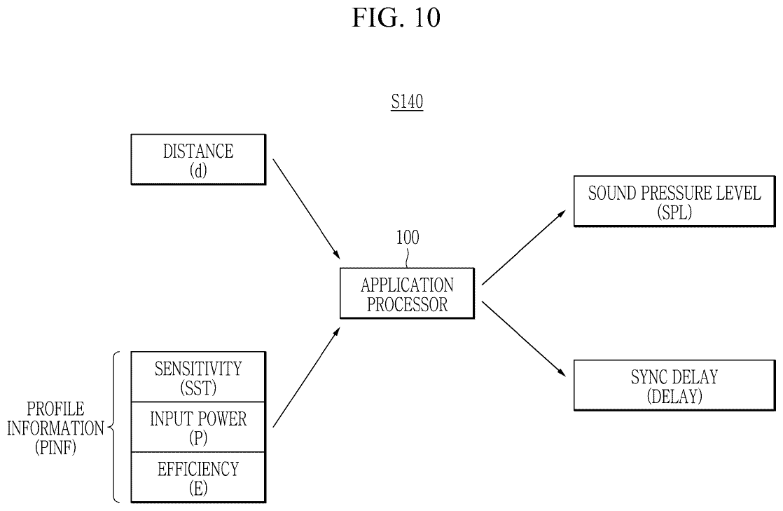

The sound surround automatic correction method S100 may include an operation S140 of calculating a sound pressure level and/or delay based on the profile information and the distance. Specifically, referring to FIG. 10, the application processor 100 of the audio source device 10 may calculate the sound pressure level SPL and the sync delay DELAY based on the calculated distance d and the acquired profile information PINF. The application processor 100 may execute an algorithm for calculating the distance d, as well as an algorithm for calculating the sound pressure level SPL and the sync delay DELAY.

Profile information PINF for a specific audio sink device 20 may include sensitivity SST, input power P, and/or efficiency E (may also be indicated by η herein) of the audio sink device 20. The application processor 100 may calculate the sound pressure level SPL based on the following mathematical Equation 1.

$$SPL = SST + 10 * {log}_{10} P + 10 * {log}_{10} η - 20 * {log}_{10} d \qquad ( Equation l )$$

Here, SPL is a sound pressure level for an audio sink device 20, SST is a sensitivity of the audio sink device 20, P is an input power of the audio sink device 20, η is an efficiency of the audio sink device 20, and d may mean a distance between an audio source device 10 and the audio sink device 20.

Additionally, the application processor 100 may calculate the delay DELAY based on the following mathematical Equation 2.

$${DELAY}_{i} = \frac{{d}_{max} - {d}_{i}}{{V}_{s}} \qquad ( Equation 2 )$$

Here, DELAYᵢ is a delay value of an i-th audio sink device among a plurality of audio sink devices 20, dₘₐₓ is a maximum value (or largest distance value) among each distance between an audio source device 10 and a plurality of audio sink devices (e.g., a value representing the distance between the audio source device 10 and the most distant audio sink device 20 among the plurality of audio sink devices), di is a distance between an audio source device 10 and an i-th audio sink device 20 among a plurality of audio sink devices, and Vₛ may denote the speed of sound in air. According to embodiments, the plurality of audio sink devices may include plurality of audio sink devices 20_1 to 20_5, but embodiments are not limited thereto. According to embodiments, the sound surround automatic correction method S100 may be performed with respect to each of the plurality of audio sink devices. Accordingly, the DELAYᵢ may be calculated with respect to each of the plurality of audio sink devices in consideration of distances corresponding to other audio sink device(s) 20 among the plurality of audio sink devices.

The sound surround automatic correction method S100 may include an operation S150 of controlling the output of an audio sink device.

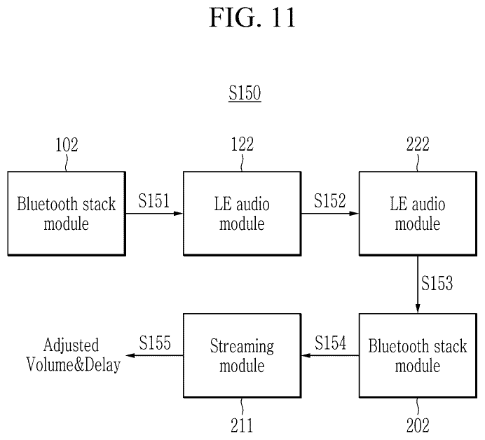

Specifically, referring to FIG. 11, the operation S150 of controlling the output of the audio sink device may include an operation S151 in which the Bluetooth stack module 102 of the audio source device 10 generates a control signal for controlling the audio sink device 20 based on the calculated sound pressure level and delay and transmits the control signal to the LE audio module 122, an operation S152 in which the LE audio module 122 transmits the control signal to the LE audio module 222 of the audio sink device 20, an operation S153 in which the LE audio module 222 of the audio sink device 20 transmits the received control signal to the Bluetooth stack module 202 of the audio sink device 20, an operation S154 in which the Bluetooth stack module 202 of the audio sink device 20 calculates an adjusted volume value and delay value based on the control signal and transmits the same to the streaming module 211 of the audio sink device 20, and/or an operation S155 of obtaining the adjusted volume value and delay value by the streaming module 211.

The sound surround automatic correction method S100 may include an operation S160 of outputting sound based on audio data.

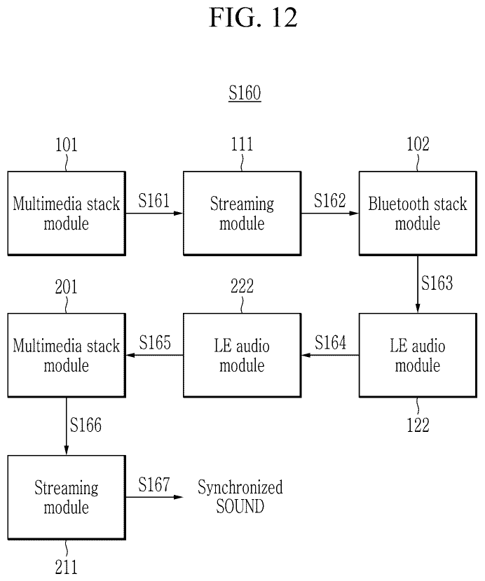

Specifically, referring to FIG. 12, the operation of outputting sound based on audio data S160 includes an operation S161 in which the multimedia stack module 101 of the audio source device 10 loads sound data from memory and transmits the sound data to the streaming module 111, an operation S162 in which the streaming module 111 converts the sound data and transmits the converted sound data to the Bluetooth stack module 102, an operation S163 in which the Bluetooth stack module 102 transmits the converted sound data to the LE audio module 122, an operation S164 in which the LE audio module 122 transmits the converted sound data to the LE audio module 222 of the audio sink device 20, an operation S165 in which the LE audio module 222 of the audio sink device 20 transmits the converted sound data to the multimedia stack module 201 of the audio sink device 20, an operation S166 in which the multimedia stack module 201 transmits the converted sound data to the streaming module 211, and/or an operation S167 of outputting synchronized sound based on the converted sound data (e.g., based on the adjusted volume and delay). According to embodiments, the audio source device 10 may adjust a magnitude (or volume) of each audio sink device 20 based on the calculated sound pressure level of the audio sink device 20, and may synchronize a plurality of audio sink devices based on the calculated delay corresponding to each audio sink device 20. According to embodiments, an audio signal provided by the audio source device 10 to each audio sink device 20 may be transformed into corresponding sound wave using a speaker (e.g., a loudspeaker) according to the adjusted magnitude and/or delay. For example, the audio signal may be represented as a time-varying voltage signal input to the speaker. A voice coil of the speaker suspended in a magnetic field may be caused to physically move back and forth according to the time-varying voltage signal. This movement of the voice coil may cause vibrations in a diaphragm of the speaker, thereby creating sound wave representative of the audio signal.

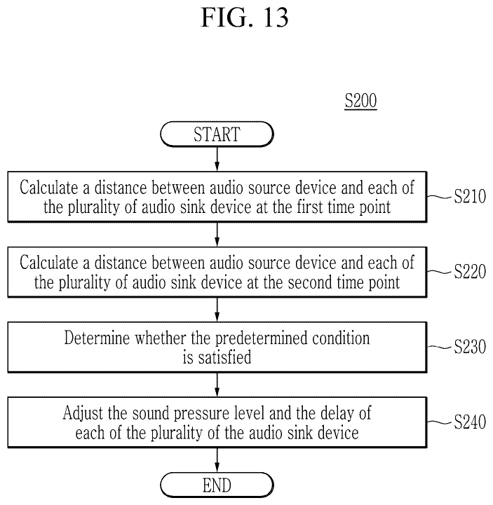

FIG. 13 is a flowchart for explaining a sound surround automatic correction method according to embodiments of the present disclosure.

Referring to FIG. 13, the sound surround automatic correction method S200 may include an operation S210 of calculating a distance between an audio source device and each of a plurality of audio sink devices at a first point in time.

The sound surround automatic correction method S200 may include an operation S220 of calculating a distance between an audio source device and each of a plurality of audio sink devices at a second point in time. That is, the distances between the audio source device and each of the plurality of audio sink devices may be recalculated at a second time point subsequent to the first time point.

The sound surround automatic correction method S200 may include an operation S230 of determining whether a predetermined (or alternatively, given or determined) condition is satisfied. The predetermined (or alternatively, given or determined) condition may include, for example, determining whether the difference between the distance (e.g., a respective distance between the audio source device and a given one among the plurality of audio sink device) calculated at a first time point and the distance recalculated at a second time point is within a predetermined (or alternatively, given or determined) threshold.

In embodiments, the predetermined (or alternatively, given or determined) condition may include, for example, determining whether the elapsed time from the first time point to the second time point is within a predetermined (or alternatively, given or determined) threshold.

That is, the sound surround automatic correction method S200 may control the output of the audio sink device in real time by calculating (e.g., recalculating) the distance when the distance between the audio source device and the audio sink device changes beyond a specific distance or at predetermined (or alternatively, given or determined) intervals.

The sound surround automatic correction method S200 may include an operation S240 of adjusting the sound pressure level and delay of each of a plurality of audio sink devices. Specifically, the audio source device may adjust the sound pressure level and delay based on the recalculated distance if a predetermined (or alternatively, given or determined) condition is satisfied.

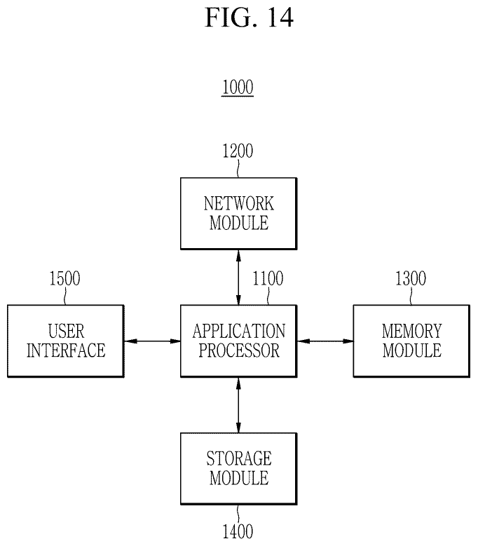

FIG. 14 is a block diagram exemplarily illustrating a mobile system according to embodiments of the present disclosure.

Referring to FIG. 14, the mobile system 1000 may include an application processor 1100, a network module 1200, a memory module 1300, a storage module 1400, and/or a user interface 1500.

The application processor 1100 may control the overall operation of the mobile system 1000, more specifically, the operation of other components that make up the mobile system 1000.

In embodiments, the application processor 1100 may receive profile information from a BT LE connected external sound output device, as described in FIGS. 1 to 13, and calculate a distance to the external sound output device based on channel sounding. The application processor 1100 may calculate the sound pressure level and delay of the sound output device based on the profile information and distance. Specific details related to this have been described with reference to FIGS. 1 to 13 and are omitted below.

The network module 1200 may communicate with external devices. For example, the network module 1200 may support wireless communications such as CDMA (Code Division Multiple Access), GSM (Global System for Mobile communication), WCDMA (Wideband CDMA), CDMA-2000, TDMA (Time Division Multiple Access), LTE (Long Term Evolution), Wimax, WLAN (Wireless Local Area Network), UWB, Bluetooth, WI-DI, etc.

The memory module 1300 may operate as a main memory, operating memory, buffer memory, or cache memory of the mobile system 1000. The memory module 1300 may include volatile random access memory such as DRAM (Dynamic Random Access Memory), SDRAM (Synchronous DRAM), DDR (Double Data Rate) SDRAM, DDR2 SDRAM, DDR3 SDRAM, LPDDR (Low-Power Double Data Rate) SDRAM, LPDDR3 SDRAM, etc., or nonvolatile random access memory such as PRAM (Phase-Change RAM), ReRAM (Resistive RAM), MRAM (Magnetoresistive RAM), FRAM (Ferroelectric RAM), etc.

The storage module 1400 may store data. For example, the storage module 1400 may store data received from outside (e.g., external to the mobile system 1000). The storage module 1400 may transmit data stored in the storage module 1400 to the application processor 1100. For example, the storage module 1400 may be implemented with a nonvolatile semiconductor memory device such as PRAM, MRAM, RRAM (Resistive RAM), NAND flash memory, NOR flash memory, three-dimensional structured NAND flash memory, etc., For example, the storage module 1400 may be provided as a solid state drive (SSD), a multimedia card (MMC), an embedded multimedia card (eMMC), a universal flash storage (UFS), etc.

The user interface 1500 may provide a connection between the mobile system 1000 and an external device that is connected to the mobile system 1000, and may exchange data with the mobile system 1000. User input may also be received via the user interface 1500. The user interface 1500 may be implemented in various interface methods such as ATA (Advanced Technology Attachment), SATA (Serial ATA), e-SATA (external SATA), SCSI (Small Computer Small Interface), SAS (Serial Attached SCSI), PCI (Peripheral Component Interconnection), PCIe (PCI express), NVMe, IEEE 1394, USB (universal serial bus), SD (secure digital) card, MMC (multi-media card), eMMC, UFS, eUFS (embedded Universal Flash Storage), CF (compact flash) card interface, etc.

Conventional devices and methods for configuring a plurality of sound output devices (e.g., speakers configured for surround sound) involve manual configuration of an output volume and delay of each of the plurality of sound output devices. However, the configuration of the output volume and delay varies with the location and profile of each of the sound output devices. Due to this complexity, manual configuration of the output volume and delay of each of the plurality of sound output devices results in insufficient sound output quality (e.g., inconsistent output volume and/or insufficient synchronization among the sound output devices).

However, according to embodiments, improved devices and methods are provided for configuring a plurality of sound output devices (e.g., speakers configured for surround sound). For example, the improved devices and methods may involve calculating the output volume and delay of each of the plurality of sound output devices based on for example, a profile of each of the plurality of sound output devices and distances from an audio source device to each of the plurality of sound output devices. Accordingly, the calculated output volume and delay of each of the plurality of sound output devices mitigates the above-described complexity to improve sound output quality (e.g., more consistent output volume and/or sufficient synchronization).

According to embodiments, operations described herein as being performed by the audio system 1, the audio source device 10, each among the plurality of audio sink devices 20_1 to 20_5, the application processor 100, the multimedia processor 110, the Bluetooth processor 120, the audio sink device 20, the application processor 200, the multimedia processor 210, the Bluetooth processor 220, the multimedia stack module 101, the Bluetooth stack module 102, the streaming module 111, the manager module 121, the LE audio module 122, the channel sounding module 123, the multimedia stack module 201, the Bluetooth stack module 202, the streaming module 211, the manager module 221, the LE audio module 222, the channel sounding module 223, the mobile system 1000, the application processor 1100, the network module 1200 and/or the user interface 1500 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), a digital signal processor, a microcomputer, a field programmable gate array (FPGA), a System-on-Chip (SoC), a programmable logic unit, a microprocessor, application-specific integrated circuit (ASIC), etc.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm, and/or functions, described in connection with embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium (e.g., the memory 130, the memory 230, the memory module 1300, the storage module 1400, etc.). A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

Embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail herein. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order. As used herein the term “and/or” includes any and all combinations of one or more of the associated listed items.

Although embodiments of the present inventive concepts have been described in detail above, the scope of the present inventive concepts is not limited thereto, and various modifications and improvements made by those skilled in the art using the basic concept of the present inventive concepts defined in the following claims also fall within the scope of the present inventive concepts.

What is claimed is:

1. A user device, comprising:
a memory; and
processing circuitry configured to cause the user device to,
generate a first request for a wireless communication connection with an external device,
generate a second request for receiving profile information of the external device,
calculate a distance to the external device,
generate a control signal for controlling an output of the external device based on the profile information and the distance,
load sound data from the memory, and
convert the sound data into a format for transmission to the external device.

2. The user device of claim 1, wherein
the wireless communication connection is based on Bluetooth Low-Energy (BT LE).

3. The user device of claim 1, wherein the processing circuitry is configured to cause the user device to calculate the distance to the external device based on channel sounding.

4. The user device of claim 1, wherein the processing circuitry is configured to cause the user device to:
adjust a magnitude of the output of the external device based on the control signal; and
synchronize the output of the external device.

5. The user device of claim 1, wherein
the profile information includes at least one of a sensitivity of the external device, an input power of the external device, or an efficiency of the external device.

6. The user device of claim 5, wherein the processing circuitry is configured to cause the user device to calculate a sound pressure level of the external device based on a mathematical formula, the mathematical formula being
$$SPL = SST + 10 * {log}_{10} P + 10 * {log}_{10} η - 20 * {log}_{10} d ,$$
SPL being the sound pressure level of the external device, SST being the sensitivity of the external device, P being the input power of the external device, η being the efficiency of the external device, and d being the distance.

7. A method for operating a user device, comprising:
generating a first request for a wireless communication connection with an external device;
generating a second request for receiving profile information of the external device;
calculating a distance to the external device;
generating a control signal for controlling an output of the external device based on the profile information and the distance; and
controlling the output of the external device.

8. The method for operating the user device of claim 7, wherein
the wireless communication connection is based on Bluetooth Low-Energy (BT LE).

9. The method for operating the user device of claim 7, wherein the calculating includes calculating the distance to the external device based on channel sounding.

10. The method for operating the user device of claim 7, wherein the controlling includes:
adjusting a magnitude of the output of the external device; and
synchronizing the output of the external device.

11. The method for operating the user device of claim 7, wherein
the profile information includes at least one of a sensitivity of the external device, an input power of the external device, or an efficiency of the external device.

12. The method for operating the user device of claim 11, wherein the method further comprises:
calculating a sound pressure level of the external device based on a mathematical formula, the mathematical formula being
$$SPL = S S T + 10 * {log}_{10} P + 10 * {log}_{10} η - 20 * {log}_{10} d ,$$
SPL being the sound pressure level of the external device, SST being the sensitivity of the external device, P being the input power of the external device, η being the efficiency of the external device, and d being the distance.

13. An audio system, comprising:
a plurality of audio sink devices; and
an audio source device configured to,
calculate distances to each of the plurality of audio sink devices at a first point in time to obtain first distances,
recalculate the first distances to each of the plurality of audio sink devices at a second point in time to obtain second distances, the second point in time being subsequent to the first point in time,
determine whether a condition is satisfied, and
adjust a sound pressure level and a delay of each among the plurality of audio sink devices based on profile information of each of the plurality of audio sink devices and the second distances in response to determining the condition is satisfied.

14. The audio system of claim 13, wherein the audio source device is configured to determine whether the condition is satisfied based on determining whether a difference between at least one of the second distances and at least one corresponding one of the first distances is within a first threshold value.

15. The audio system of claim 13, wherein the audio source device is configured to determine whether the condition is satisfied based on determining whether a time difference between the second point in time and the first point in time is within a second threshold value.

16. The audio system of claim 13, wherein the audio source device is configured to synchronize an output of each of the plurality of audio sink devices based on the delay of each of the plurality of audio sink devices.

17. The audio system of claim 13, wherein the audio source device is configured to connect to each of the plurality of audio sink devices based on Bluetooth Low-Energy (BT LE).

18. The audio system of claim 13, wherein the audio source device is configured to calculate the first distances to each of the plurality of audio sink devices based on channel sounding.

19. The audio system of claim 13, wherein
the profile information of each of the plurality of audio sink devices includes at least one of a sensitivity of each of the plurality of audio sink devices, an input power of each of the plurality of audio sink devices, and an efficiency of each of the plurality of audio sink devices.

20. The audio system of claim 19, wherein the audio source device is configured to calculate the delay of each of the plurality of audio sink devices is calculated based on a mathematical formula, the mathematical formula being
$${DELAY}_{i} = \frac{{d}_{max} - {d}_{i}}{{V}_{s}} ,$$
DELAYᵢ being a delay value of an i-th audio sink device among the plurality of audio sink devices, dₘₐₓ being a maximum value among the second distances, di being a distance between the audio source device and the i-th audio sink device among the plurality of audio sink devices, and Vₛ being a speed of sound in air.
